(19) United States
(12) Patent Application Publication
(10) Pub. No.: US 2009/0014437 A1
(43) Pub. Date: Jan. 15, 2009

(54) GLASS-COATED METALLIC FILAMENT CABLES FOR USE IN ELECTRICAL HEATABLE TEXTILES

(75) Inventors: Wim Van Vooren, Waregem (BE); Steve Verstraeten, Antwerpen (BE); Pol Speleers, Waregem (BE)

Correspondence Address: FOLEY AND LARDNER LLP;SUITE 500, 3000 K STREET NW, WASHINGTON, DC, 20007, US

(73) Assignee: NV Bekaert SA

(21) Appl. No.: 12/281,390

(22) PCT Filed: Feb. 6, 2007
(86) PCT No.: PCT/EP2007/051105

§ 371 Date: Sep. 2, 2008

(30) Foreign Application Priority Data
Mar. 3, 2006 (EP) 06110652.2

(51) Int. Cl. H05B 3/56

(52) U.S. Cl. 219/548

(57) ABSTRACT

The present invention provides a heating element with electrically insulated metallic filaments wherein those metallic filaments have a diameter of 2 to 200 μm, each metallic filament is separately electrically insulated and the electric insulation is a continuous and coherent glass coating. This provides thus a product which is very corrosion and oxidation resistant and has a high cut resistance. The high cut resistance makes it highly suitable for being sewn in textiles, e.g. in car seating. A further advantage of the invention is the small dimensions of the material used which make it more flexible thereby increasing the wear resistance and also increasing the flexibility for use, e.g. weaving, knitting or braiding the product into textile products. The metallic filaments can be of a metal with a specific electrical resistance between 17 and 2000 Ω.mm²/km. Preferably, a specific electrical resistance between 17 and 200 Ω.mm²/km, even more preferably, a specific electrical resistance between 17 and 100 Ω.mm²/km.

### FIELD OF THE INVENTION

The present invention relates to the field of electrical heating elements. The invention further relates to the use of heating cables in electrical heatable applications in textiles, e.g. seats in cars.

### BACKGROUND OF THE INVENTION

For reasons of comfort and security electrical heatable seats are used in vehicles of today. This is achieved by special heating cables in the form of one or more loops in the respective seat. Heating cables are normally placed in seat and back of seat.

Such heating cable is then connected to a power feeding unit that delivers current, whereby the element can be warmed up to a suitable temperature.

According to the prior art, heating wires consist of a wire bundle with a relatively large number of wires, e.g. 15-150 pieces, so called strands. These strands consist of thin electrically conductive wires that are interlaced or made up into bundles in such a way that they together form the complete heating element. Each one of the strands may have a diameter that is of a magnitude of about 0.05 mm.

Normally this heating wire admits a reliable heating and temperature regulation for use in a vehicle seat, but there are some drawbacks. One such disadvantage relates to the fact that the different strands may be worn as time passes, be it by wear out, be it by formation of corrosion and oxidation, both resulting in reductions in cross-sectional areas of the strands. This is followed by localized overheating, the so called hot-spot formation. Finally this leads to a breakage of the heat conductor, resulting in shortened service life of the heat conducting element.

One of the prior art solutions is given in EP1261264 which resolves the hot-spot formation which occurs at the interruption in the strand. This solution provides a device for heating wherein the heating cable is constructed of a number of strands of which a predetermined number of strands are individually electrically insulated with an insulating lacquer layer. Although the lacquer layer provides for the electrical insulation, it still is very vulnerable, as this patent explains that a relatively large number of strands create the necessary conditions for being sewed into a seat without occurrence of any errors, for example that needles may hit and damage the strands during a sewing process, implicating that a possible loss of strands is already reckoned with.

Moreover, the provision of a lacquer layer on the individual strands is an additional process step which is expensive having regard to the number of strands and to the small diameter of the strands.

Another disadvantage of the known heating wire is the restricted flex life, which means that the life time of the known heating wires is limited due to repeated bendings. This flex life can be increased by decreasing the diameter of the individual strands. Decreasing the diameter of the strands, however, exponentially increases the cost and energy of the traditional wire-drawing process.

EP1337129 describes an alternative solution to the hot-spot problem by providing a core-coated wire which in itself is strong enough to withstand the high mechanical stresses experienced by an electrical heating unit in the seat in a motor vehicle. To obtain this strength the wire has a core of copper or copper alloy and the coating is of steel, or the other way around where the wire is made of steel and the coating is made of copper or copper alloy. To protect this wire against the corrosion from external influences, the wire is provided with an outer electrical insulation of polytetrafluoroethylene (PTFE), copolymers of tetrafluoromethylene and hexafluoropropylene (FEP), perfluoroalkoxy polymer (MFA) or polyurethane lacquer.

Here also, the provision of a lacquer layer on the individual wires is an additional process step which is expensive having regard to the number of wires.

And also the additional coating of the core-wire is an extra process step which renders the complete prior art solution rather expensive and time consuming.

### SUMMARY OF THE INVENTION

It is an object of the invention to provide an electrical heating cable that avoids the aforementioned drawbacks.

It is an object of the invention to provide a heating cable that can be sewn in a textile. Another object of the invention is to provide a heating cable that can withstand the high mechanical stresses experienced by an electrical heating unit in a seat, especially in a seat of a motor vehicle.

Another object of the invention is to provide a heating element that can be used in electrical heatable textiles, in particular clothing, e.g. vests, gloves, socks, stockings, sportsbandages. Another object of the invention is to provide a heating cable which has an outstanding electrical conductivity paired with a low susceptibility to corrosion and oxidation.

Another object of the present invention is a relatively low manufacturing cost of the heating cable.

Still another object of the invention is a more prolonged flexlife of the individual strands which can reduce the amount of strands necessary in the heating cable to secure a certain lifetime of the heating element.

A main purpose of the invention is thus to provide an alternative device for heating of a vehicle seat preventing the risk of hot-spot formation, by providing an alternative for the electrical insulation.

The present invention provides a heating cable with electrically insulated metallic filaments wherein those metallic filaments have a diameter of 2 to 200 μm, each metallic filament is separately electrically insulated and the electric insulation is a coherent and continuous glass coating. With the term continuous and coherent glass coating it is meant a glass coating which is coherent and continuous, smooth, in longitudinal direction and is therefore substantially different from a wound strip of fibreglass.

This provides thus a product which is very corrosion and oxidation resistant and has a high cut resistance. The high cut resistance makes it highly suitable for being processed in textiles, e.g. in car seating or clothing. A further advantage of the invention is the small dimensions of the material used which make it more flexible thereby increasing the wear resistance and also increasing the flexibility for use, e.g. weaving, knitting or braiding the product into textile products.

The metallic filaments can be of a metal with a specific electrical resistance between 17 and 2000 Ω.mm²/km. Preferably, a specific electrical resistance between 17 and 200 Ω.mm²/km, even more preferably, a specific electrical resistance between 17 and 100 Ω.mm ²/km.

In a second aspect of the invention the glass coating is obtainable by using the Taylor-Ulitovskii process for obtaining the metallic filaments or a similar process wherein the glass and metallic filaments are produced simultaneously. The basis theory of these processes is described by Taylor G., Phys. Rev. 23, 655-660 (1924) and in U.S. Pat. No. 1,793,529 to Taylor. Consequently, there is no need for a separate coating process which reduces the coating costs and production time. The Taylor-Ulitovskii process and equivalents make it possible to obtain very small diameters of the metallic filaments. This fine filament has enhanced mechanical properties and makes it very flexible for design purposes, e.g. the small diameter of the metallic filament together with the glass coating makes it suitable to be woven, knitted or braided into textiles.

### BRIEF DESCRIPTION OF THE DRAWINGS

FIG. 1: assembly of a heating cable according to the present invention

FIG. 2: other assembly of a heating cable according to the present invention

FIG. 3: other assembly of a heating cable according to the present invention

### DESCRIPTION OF THE PREFERRED EMBODIMENTS OF THE INVENTION

When describing the invention, the terms used are to be construed in accordance with the following definitions, unless a context dictates otherwise:

As used herein, the term “heating cable” means an electrical conductive wire containing at least one coated metallic filament.

The term “heating element” is the assembly of the heating cable together with the connections embedded in the usual applications, e.g. a heating cable sandwiched between two foam bodies.

The term “plastic material” refers to every polymeric material that can withstand prolonged heat, i.e. temperatures above 150° C., e.g. polytetrafluoroethylene (PTFE), copolymers of tetrafluoromethylene and hexafluoropropylene (FEP), perfluoroalkoxy polymer (MFA), polyurethane lacquer or PVC.

The term “type of metallic filament” is always a filament which is made of one type of metal or metal alloy.

The term “electrically insulated metallic filaments” means that each metallic filament is separately electrically insulated.

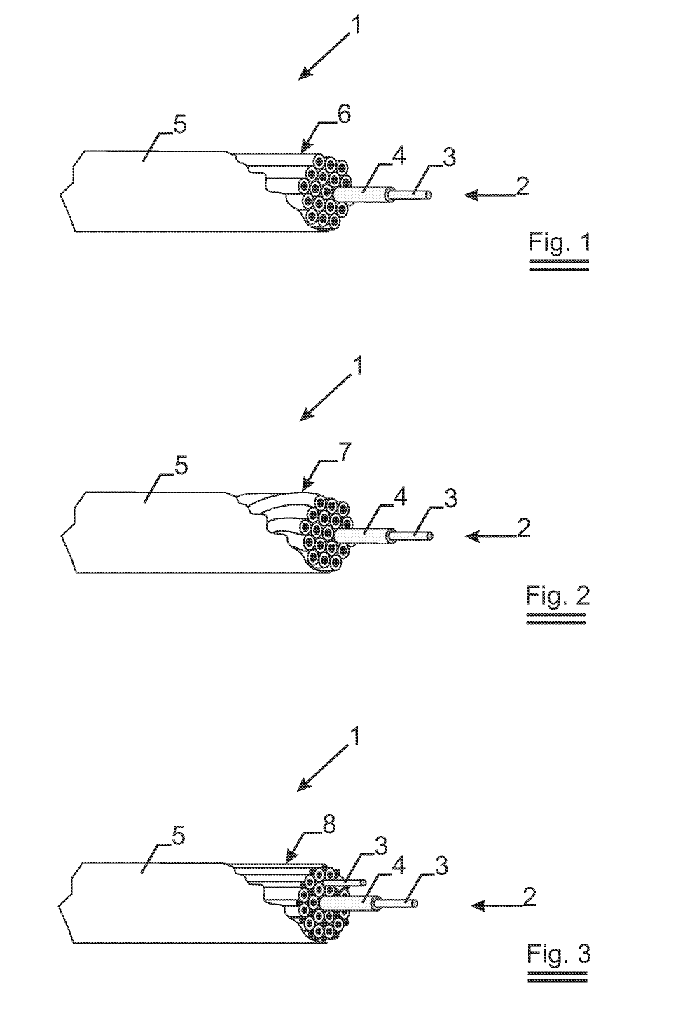

FIG. 1 shows a first embodiment of the present invention. A heating cable 1 having electrically insulated metallic filaments 2. Those electrically insulated metallic filaments 2 have a diameter of 2 to 200 μm and the electric insulation 4 is a glass coating. This glass coating constitutes about 2 to 30% of the total diameter of the glass-coated metallic filament, preferably 5 to 10%.

The metallic filaments 3 are electrically conductive and are made of an electrically conductive material such as copper, nickel, cupro-nickel, stainless steel or other suitable metal or metal alloy with good conductive characteristics.

The metallic filaments can be of a metal with a specific electrical resistance between 17 and 2000 Ω.mm²/km. Preferably, a specific electrical resistance between 17 and 200 Ω.mm²/km, even more preferably, a specific electrical resistance between 17 and 100 Ω.mm ²/km.

In addition to the electrical insulation, the glass coating 4 makes the metallic filaments 3 corrosion and oxidation resistant.

A heating cable which has more than one glass-coated metallic filament can readily be stitched on textiles without being damaged by the needle because the glass coating also makes it cut resistant. The glass coating 4 also provides an electrical insulation which prevents the metallic filaments to be in electrical contact with each other. This prevents the so-called hot-spot formation when, e.g. due to high mechanical stresses, one or more of the metallic filaments are interrupted.

Preferably, the glass coating is obtainable by using the Taylor-Ulitovskii process for obtaining the metallic filaments, wherein the glass and metallic filaments are produced simultaneously. Thereby reducing coating costs and production time, and obtaining very small diameters of the metallic filaments. This fine filament has enhanced mechanical properties and makes it very flexible for design purposes, e.g. the small diameter of the metallic filament together with the glass coating makes it suitable to be woven, knitted or braided into textiles.

In a second embodiment, the invention provides for a heating cable wherein a bundle 7 of insulated metallic filaments is twisted as in FIG. 2. Alternatively, the bundle 6 can also be in parallel, as in FIG. 1.

In a further embodiment the invention provides a heating cable which contains at least one type of metallic filaments which all have a glass coating. The bundle 6 or 7 can then contain different types of glass-coated metallic filaments which facilitates the modulation of the desired resistance for the heating cable. The bundle 6 or 7 can be twisted or in parallel.

In another embodiment one can provide a heating cable containing a bundle 8 of glass coated metallic filaments 2 combined with non-coated metallic filaments 3 as in FIG. 3. The uncoated filaments 3 can be in at least one type of metal or metal alloy which provides strength to the bundle, e.g. stainless steel. The glass-coated filaments 2 can than be in a metal which has a good specific electrical resistance e.g. copper, nickel, iron. Or even more than one metal or metal alloy type of glass-coated filament can be used to provide the necessary specific electrical resistance to the heating element.

In a further embodiment the heating cable is embedded in a plastic material 5, e.g. polytetrafluoroethylene (PTFE), copolymers of tetrafluoromethylene and hexafluoropropylene (FEP), perfluoroalkoxy polymer (MFA), polyurethane lacquer or PVC.

In another embodiment the heating cable contains glass-coated metallic filaments wherein those filaments are obtained via the Taylor-Ulitovskii method. The metallic filaments are made of ferrous or non-ferrous, amorphous or crystalline metal.

A further embodiment of the invention provides a textile structure with at least one heating cable as described above wherein the heating cable is processed into/stitched in or on the textile.

The heating cable can than be used in a heating element wherein the heating cable makes contact with the power supply in any known way in the art.

Next to the use in car seat heating, the heating cable and heating element can also be used in clothing such as vests, gloves, stockings, socks, . . .

1. A heating cable comprising electrically insulated metallic filaments, wherein said metallic filaments have a diameter of 2 to 200 μm, each metallic filament is separately electrically insulated and said electric insulation comprises a continuous and coherent glass coating.

2. A heating cable according to claim 1, wherein said metallic filaments are made of ferrous or non-ferrous, amorphous or crystalline metal.

3. A heating cable according to claim 1, wherein said glass-coated metallic filaments are obtainable via the Taylor-Ulitovskii method.

4. A heating cable according to claim 1, wherein said heating cable is constructed in the form of a bundle of glass-coated metallic filaments.

5. A heating cable according to claim 1, wherein said heating cable is constructed in the form of a bundle of glass-coated metallic filaments next to uncoated metallic filaments.

6. A heating cable according to claim 4, wherein said bundle of glass-coated metallic filaments comprises at least one type of metallic filaments which all have a glass coating.

7. A heating cable according to claim 5, wherein said bundle of glass-coated and uncoated metallic filaments comprise at least one type of metallic filaments.

8. A heating cable according to claim 5, wherein the bundle of coated and/or uncoated metallic filaments is twisted.

9. A heating cable according to claim 4, wherein the bundle comprises parallel coated and/or uncoated metallic filaments.

10. A heating cable according to claim 1, wherein the heating cable is embedded in a plastic material.

11. A heating cable according to claim 1, wherein the heating cable is extruded in PTFE.

12. A textile structure comprising at least one heating cable according to claim 1, wherein said heating cable is integrated in the textile structure.

13. A textile structure comprising at least one heating cable according to claim 1, wherein said heating cable is integrated in a car seat.
